(19) United States
(12) Patent Application Publication
(10) Pub. No.: US 2016/0253526 A1
(43) Pub. Date: Sep. 1, 2016

(54) SECURE DATA ENTRY DEVICE

(71) Applicant: POWA TECHNOLOGIES LIMITED, London (GB)

(72) Inventors: Steve MCFALL, London (GB); Dan WAGNER, London (GB)

(21) Appl. No.: 15/027,205

(22) PCT Filed: Oct. 2, 2014
(86) PCT No.: PCT/GB2014/052986

§ 371 Date: Apr. 4, 2016

(30) Foreign Application Priority Data
Oct. 2, 2013 (GB) 1317462.8

(51) Int. Cl. G06F 21/83; G06F 21/86

(52) U.S. Cl. CPC G06F 21/83; G06F 21/86

(57) ABSTRACT

A secure data entry device comprising electronic circuitry, a keypad in communication with the electronic circuitry for inputting data and a cover arranged between the keypad and the electronic circuitry to prevent access to the electronic circuitry. A system is also provided comprising the secure data entry device and a communication device, wherein the secure data entry device and the communication device are configured to communicate with each other.

### FIELD OF THE DISCLOSURE

The present invention relates to a secure data entry device. It also relates to a system comprising the secure data entry device.

### BACKGROUND

Data entry devices are employed in many situations and it is a common requirement that they are secure. Accordingly, secure data entry devices are available that resist unauthorised access to the internal circuitry of the data entry device, especially the circuitry that processes or stores sensitive information.

An example of a data entry device that is required to be secure is a personal identification number (PIN) entry device (PED). PEDs are used to process payments securely. Such devices have a keypad for the customer to input their PIN along with internal circuitry which encrypts the customer's information for external transmission. Therefore, it is of the upmost importance that the circuitry within the PED that carries sensitive information is secure from external attack. This is recognised by the existence of security standards for such devices administered by the PCI Security Standards Council. Previous secure data entry devices have used a security mesh to enclose and protect sensitive circuitry.

### SUMMARY OF THE DISCLOSURE

The present disclosure relates to arrangements that improve the security for sensitive circuits without resorting to complex and elaborate approaches.

In accordance with one aspect of the present disclosure, there is provided a secure data entry device comprising: electronic circuitry; a keypad in communication with the electronic circuitry for inputting data; and a cover arranged between the keypad and the electronic circuitry to prevent access to the electronic circuitry. The keypad may be for entering data for processing by the electronic circuitry.

The cover may be a layer, such as protective layer or a security layer. The cover may comprise a substrate. The cover may comprise a conductive trace. The cover may comprise a mesh, such as a fine wire mesh. The mesh may comprise a metallic material. The mesh may comprise a substrate and/or a conductive trace. The mesh may be separate from the keypad. The mesh may be secured in place on the electronic circuitry with adhesive, for example by at least one adhesive contact or pad, a plurality of adhesive contacts or pads, four adhesive contacts or pads, or four or more adhesive contacts or pads.

The secure data entry device is both small and very resistant to attack. The cover prevents access by probing devices to the underlying electronic circuitry, particularly the circuitry relating to the keypad circuits. In addition, probe attacks from above penetrating the cover will register an attack, Moreover, attempts to lift the cover will cause it to lose contact with the electronic circuitry below and thus register an attack.

The keypad may comprise at least one key, a plurality of keys, twelve keys, or twelve keys or more.

The electronic circuitry may comprise a key-press detection component corresponding to at least one key, or each key. The at least one key, or each key may be arranged to be in communication with its corresponding key-press detection component such that a key-press of at least one key, or each key, is detectable by the electronic circuitry.

The cover may be located between a key-press detection component and its corresponding key.

At least one key-press detection component, or each key-press detection component, may comprise: a conductive inner component, such as a conductive inner ring, on the electronic circuitry; a conductive outer component, such as a conductive outer ring, on the electronic circuitry; and a conductive dome, wherein a portion of the dome is in contact with the outer component.

The dome may be a convex dome extending away from the electronic circuitry. The dome may be deformable between a first position in which the dome does not contact the inner ring and a second position in which the dome contacts the inner ring. The inner ring, the outer ring and/or the dome may comprise metallic material. The dome may be secured in place on the electronic circuitry with adhesive. The dome may be secured in place on the electronic circuitry with adhesive tape, resulting in a very strong and secure structure.

The cover may be in contact with at least one key, a plurality of keys, four keys, four keys or more, or all of the keys. Each one or more keys which contact the cover may be positioned at a corner of the keypad. The cover may be secured to at least one key, a plurality of keys, four keys, or four keys or more with adhesive, for example by at least one adhesive contact or pad, a plurality of adhesive contacts or pads, four adhesive contacts or pads, or four or more adhesive contacts or pads.

The electronic circuitry further comprises at least one security element, a plurality of security elements, or four security elements. The security element may comprise a tamper detection means, such as a tamper switch. Each security element comprises an inner security component or first security component, such as an inner security ring or first security ring, and an outer security component or second security component, such as an outer security ring or second security ring. The inner security ring and the outer security ring may be substantially like the inner ring and outer ring, respectively, of the key-press detection component. The electronic circuitry may be adapted to detect changes in conductivity via at least one of the security element(s). At least one of the security element(s), a plurality of the security elements, or all of the security elements may be connected to the cover and/or the keypad. The inner and outer security rings may be concentric. At least one of the security element(s), a plurality of the security elements, or all of the security elements may further comprise a third security component or a guard component, such as a third security ring or a guard security ring, which may be substantially like the inner and outer security rings and may substantially or entirely surround (e.g. concentrically) the inner and outer security rings. The first, second and/or third security rings may be in contact with the keypad and/or the cover. The electronic circuitry may be adapted to detect changes in conductivity via the first, second and/or third security rings resulting from the keypad and/or the cover being disconnected from the first, second and/or third security rings e.g. in an attempt to access the electronic circuitry by removing a component of the secure data entry device, such as the keypad or the cover. Some malicious attempts to access the electronic circuitry involve injecting conductive fluid into the secure data entry device or placing a conductive member within the secure data entry device to maintain conductivity through the security element whilst the keypad and/or cover is removed. The electronic circuitry may be adapted to detect a change in conductivity via the third security ring when such a conductive fluid or conductive member is applied such that attempts to access the electronic circuitry in this way can be detected and an alarm can be raised. The third security ring may also form a physical barrier to prevent the malicious application of a conductive liquid or conductive member into the secure data entry device.

The cover, for example a mesh, may be in the form of conductive traces on a substrate. Traces of the mesh may be 0.17 mm or less in width and/or spaced 0.17 mm or less apart. It is found that this width and spacing provides a high level of security for the underlying components. The mesh substantially covers the regions of the substrate for which protection is desired. The traces may overlap and/or connect with each other. The traces may be in the form of lines that extend for a variety of distances in a plurality of directions. In particular, the traces may comprise regions where the traces run substantially parallel. It is preferred that the traces do not possess any long range order, i.e. it is preferred that the traces do not have a repeating pattern. The absence of such order increases security by minimising the possibility of predicting the location of the traces.

The mesh may be present between or within layers of components of the secure data entry device. For example, the substrate that contains the electronic circuitry, e.g. the PCB, may be formed from a plurality of layers and the mesh, particularly in the form of conductive traces, may be formed on or within one or more of these layers. This provides further protection by registering any tampering event that disrupts a conductive trace. It is particularly desirable to provide mesh on one or more layers of the substrate so that a mesh is present on one or both sides of the substrate layers that route security sensitive signals, such as data input signals or signals read from a removable data medium. In this way, layers of the substrate that route such sensitive signals can be closely protected by security mesh on neighbouring layers. Any such layered components may comprise a first planar surface and a second planar surface. The first and second planar surfaces may be opposing external surfaces of the layered component that extend substantially parallel to the major faces of the layers. A mesh can be provided on or within the first, second, third, fourth and/or further layer, where the first planar surface is a surface of the first layer of the layered component and the other layers are numbered consecutively away from the first layer. Alternatively or additionally, a mesh can be provided on or within the first, second, third, fourth and/or further layer from the second planar surface, where the second planar surface is a surface of the first layer of the layered component and the other layers are numbered consecutively away from the first layer. For example, a mesh can be provided on or within the second layer relative to the first planar surface and/or the second layer relative to the second planar surface. The layered component may comprise eight layers and a mesh may be provided on or within the second and/or seventh layers relative to the first planar surface and/or the second planar surface.

In a similar way, a security frame may also be formed from a plurality of layers. One or more of these layers may have a mesh (as described herein), particularly in the form of conductive traces, formed thereon or within the layer(s). Again, this provides added security within the security frame and assists in registering tamper events that disrupt the mesh.

The electronic circuitry may further comprise a removable data-storage medium reader for receiving a data-storage medium containing data. The data-storage medium may be a card, such as a chip and/or smart card. The electronic circuitry may comprise processing circuitry for processing data read by the data-storage medium reader and data input using the keypad, e.g. for cross-checking a code, such as a PIN, input by the keypad with data stored on the data-storage medium to confirm whether the data is sufficiently similar or identical, and if so, proceeding with reading other data from the removable data-storage medium and/or performing actions such as proceeding with a transaction, such as a card payment transaction (when a card is inserted as the removable data storage medium) into the reader. The data-storage medium reader may comprise an integrated circuit card (ICC) or smartcard receptor. The secure data entry device may further comprise a user interface in communication with the electronic circuitry. The user interface may comprise a display. For example, the display screen may be an LCD display screen.

The secure data entry device may be configured to be powered by one or more batteries. The secure data entry device may further comprise a Bluetooth module. The secure data entry device may be a personal identification number (PIN) entry device (PED). The electronic circuitry may be a circuit board, such as a printed circuit board (PCB).

In accordance with a second aspect of the present disclosure, there is also provided a system comprising: a secure data entry device according to an embodiment of the invention; and a communication device, wherein the secure data entry device and the communication device are configured to communicate with each other.

The secure data entry device and the communication device may be configured to communicate with each other via Bluetooth. The communication device may be a mobile communication device (MCD). The MCD may be a smartphone. The communication device may be configured to communicate with an external system. The MCD may be configured to communicate with an external system by means of an application stored on the MCD. The external system may be a payment acquirer.

### BRIEF DESCRIPTION OF THE DRAWINGS

The invention is described below, by way of example only, with reference to the accompanying drawings, in which:

FIG. 1 is a perspective view of a secure data entry device according to an embodiment of the invention;

FIG. 2 is a cut-away view of a key-press detection component according to an embodiment of the invention;

FIG. 3 is a plan view of electronic circuitry according to an embodiment of the invention;

FIG. 4 is a plan view of a portion of electronic circuitry according to an embodiment of the invention;

FIG. 5 is a schematic view of a key detection circuit and a key-press detection component or security component according to an embodiment of the invention.

FIG. 6 is an exploded view of a cover and electronic circuitry according to an embodiment of the invention;

FIG. 7 shows a cross-sectional view of a secure data entry device according to an embodiment of the invention; and

FIG. 8 shows a mesh according to an embodiment of the invention.

### DETAILED DESCRIPTION

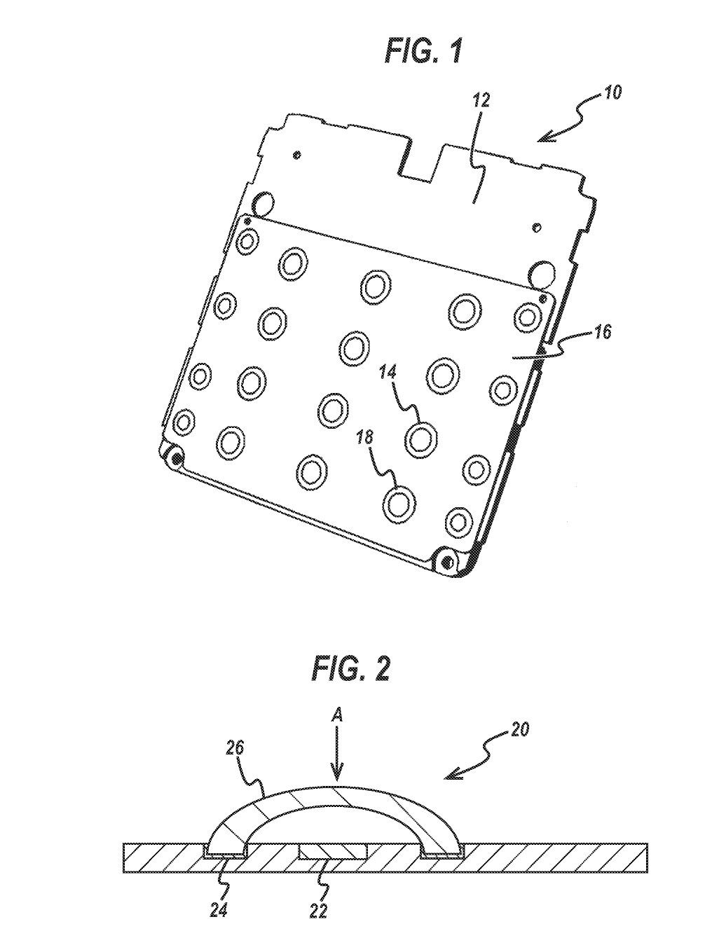

FIG. 1 shows a perspective view of a secure data entry device 10, such as a personal identification number (PIN) entry device (PED), according to an embodiment of the invention. The secure data entry device 10 comprises electronic circuitry 12, for example a circuit board, such as a printed circuit board (PCB), a keypad 14 in communication with the electronic circuitry for inputting data, and a cover 16 arranged between the keypad 14 and the electronic circuitry 12 to prevent access to the electronic circuitry 12. In the embodiment shown in FIG. 1, the cover 16 is a mesh which may be made from a metallic material and/or be a fine wire mesh. References to the “mesh” herein will generally be understood as references to the “cover”.

The mesh 16 is separate from the keypad 14, and is secured in place on the electronic circuitry 12 with adhesive. In the exemplary embodiment shown in the figures, the keypad 14 comprises twelve keys 18. However, in alternative embodiments, the keypad 14 may comprise at least one key, a plurality of keys, twelve keys, or twelve keys or more. The skilled person will understand that any suitable number of keys can be used. The keys 18 of the keypad 14 are accessible to a user to permit the user to press the keys 18 to input data, such as one or more alphanumeric characters or any other character.

The electronic circuitry 12 comprises a key-press detection component 20 corresponding to each key 18 of the keypad 14. FIG. 2 shows a cut-away view of a key-press detection component 20 according to an embodiment of the invention. Each key 18 is arranged to be in communication with its corresponding key-press detection component 20 such that a key-press of each key 18 is detectable by the electronic circuitry 12.

Each key-press detection component 20 comprises a conductive inner ring 22 (or contact, such as a spot contact) on the electronic circuitry 12, a conductive outer ring 24 on the electronic circuitry 12, and a conductive dome 26. A portion of the dome 26 is in contact with the outer ring 24. As shown in FIG. 2, the outer perimeter of the dome 26 is in contact with the outer ring 24. Typically, the inner ring 22, outer ring 24 and dome 26 are made of a conductive material, for example a metallic material, such as gold.

The dome 26 is a convex dome 26 extending away from the electronic circuitry 12, and is deformable between a first position in which the dome 26 does not contact the inner ring 22 and a second position in which the dome 26 contacts the inner ring 22. When the dome 26 contacts the inner ring 22, for example as a result of pressure applied by a user on the key 18 corresponding to the key-press detection component 20 concerned, a key-press is registered, i.e. the electronic circuitry 12 is adapted to detect the change in conductivity, e.g. the shorting of the outer ring 24 to the inner ring 22 via the dome 26. The dome 26 is typically secured in place on the electronic circuitry 12 with adhesive and/or adhesive tape, resulting in a very strong and secure structure.

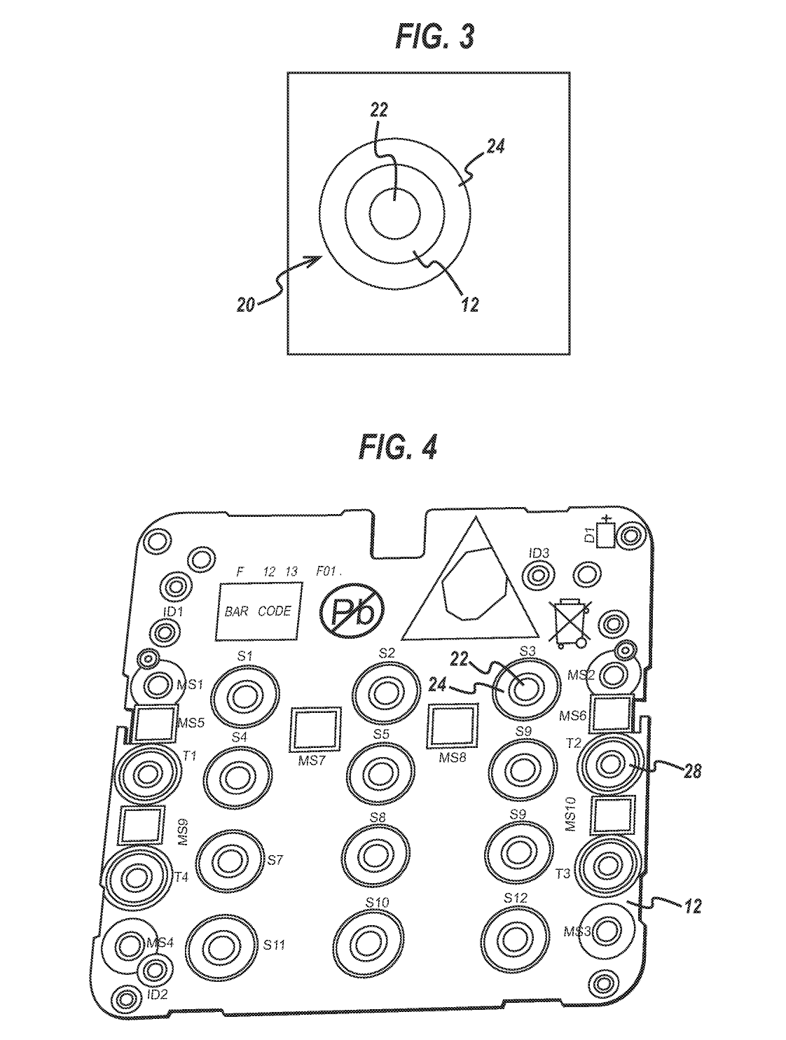

FIG. 3 shows the inner ring 22 and outer ring 24 in more detail. As discussed previously, the inner ring 22 and outer ring 24 are typically concentric and are made of a conductive material, for example a metallic material, such as gold. Of course, reference has been made herein to outer and inner “rings”. However, it will be appreciated that other geometries are useable which utilise an outer conductive component surrounding an inner conductive component.

The electronic circuitry 12 further comprises at least one security element 28. Each security element 28 comprises an inner security ring and an outer security ring. In an exemplary embodiment, the inner security ring and the outer security ring are concentric and are substantially like the inner ring 22 and outer ring 24, respectively, of the key-press component. For example, they are typically mounted on the electronic circuitry 12 and are made from a conductive material, for example a metallic material, such as gold. Of course, it will be appreciated that other geometries are useable which utilise an outer security conductive component surrounding an inner security conductive component. In one embodiment (not shown), the security element further comprises a guard ring which surrounds, is substantially similar to, and is concentric with the inner security ring 22 and outer security ring 24. Like the inner 22 and outer 24 security rings, the guard security ring is connected to the keypad 14 and/or the cover 16. The electronic circuitry 12 is adapted to detect changes in conductivity via the inner 22, outer 24 and/or guard security rings resulting from the keypad 14 and/or the cover 16 being disconnected from the inner 22, outer 24 and/or guard security rings e.g. in an attempt to access the electronic circuitry 12 by removing a component of the secure data entry device 10, such as the keypad 14 or the cover 16. Some malicious attempts to access the electronic circuitry 12 involve injecting conductive fluid into the secure data entry device 10 or placing a conductive member within the secure data entry device 10 to maintain conductivity through the security element 28 whilst the keypad 14 and/or cover 16 is removed. The electronic circuitry 12 may be adapted to detect a change in conductivity via the guard security ring when such a conductive fluid or conductive member is applied such that attempts to access the electronic circuitry 12 in this way can be detected and an alarm can be raised. The guard security ring may also form a physical barrier to prevent the application or injection of a conductive liquid into the secure data entry device 10 to corrupt, alter or access the electronic circuitry 12.

The electronic circuitry 12 is adapted to detect changes in conductivity via each security element 28, each of which can be connected to the cover 16. As a result, movement of the cover 16 so that it becomes detached from one or more of the security elements 28 or changes its position on the security elements 28, or manipulation of the cover 16, e.g. via a metallic probe, can be detected by the electronic circuitry 12 which detects slight changes in conductivity via one or more of the security elements 28.

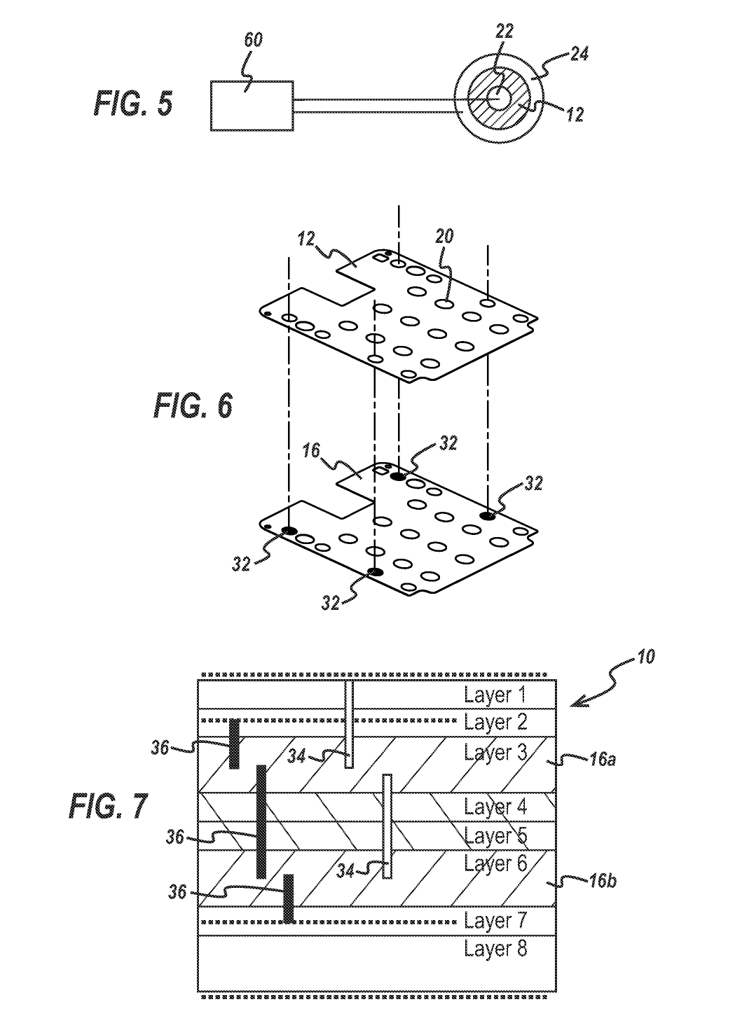

Each key-press detection component 20 and/or security element 28 is adapted to pass electrical current between its outer and inner conductive components such that changes in the conductivity can be detected, for example as a result of the dome contact or cover manipulation mentioned above. This conductivity change is detectable by a detection circuit 60 (see FIG. 5) on the electronic circuitry 12 and connected to one or more or all of the key-press detection components 20 and/or security elements 28. The detection circuit 60 is adapted to take preventative action when intrusive manipulation via the keypad is detected, e.g. via manipulation or probing of the cover 16. The detection circuit 60 is also adapted to pass the aforementioned current to each key-press detection component 20 and/or security element 28. Such preventative action may include one or more of: disabling some or all functionality provided by the electronic circuitry 12, displaying a warning; sounding an alert etc. This may be achieved since the detection circuit 60 is connected to or comprised within other processing circuitry (not shown) on the electronic circuitry 12 which performs the conventional functions of the electronic circuitry 12.

An additional benefit of providing a cover (e.g. mesh) 16 according to the invention is that it makes it difficult or impossible to distinguish the pressing of one key (i.e. by applying pressure to a key 18 such that the dome 26 contacts the inner ring 22, as described above) from the pressing of another key. Therefore, anyone attempting to breach the security of the device by trying to detect which keys are being pressed is prevented from doing so. In particular, the inclusion of a cover 16 according to the invention means that pressing any key results in the same mechanical sound and/or the same electro-magnetic (EM) emission and/or the same power consumption. Thus, any person monitoring key presses using a detection means (e.g. a microphone, an EM detector or a power meter) would be unable to distinguish any key press from any other key press. Therefore, the cover 16 improves the security of the device in this way.

FIG. 4 shows exemplary electronic circuitry 12 in the form of a printed circuit board (PCB) with twelve sets of inner 22 and outer 24 rings corresponding to twelve key-press components, as described previously, and four sets of inner and outer security rings.

As shown in FIG. 1, the cover 16 is located between each key-press component 20 and its corresponding key 18. The cover 16 is typically in contact and/or fixed to one or more, or all of four keys 18 located at the four corners of the keypad 14. This configuration prevents the cover 16 from being lifted thereby improving the security of the device. However, the skilled person will understand that least one key, a plurality of keys, four keys, or four keys or more may be in contact with the cover 16.

As discussed above with reference to FIGS. 1 and 2, the cover 16 is typically attached or fixed to the electronic circuitry 12 using adhesive. FIG. 6 shows an exploded view of a cover 16 and electronic circuitry 12, such as a PCB, which are attached or fixed to each other using adhesive. In particular, the cover 16 (e.g. a mesh) and the electronic circuitry 12 are attached to each other by one or more adhesive contacts or pads 32. In the embodiment shown in FIG. 6, the cover 16 comprises four adhesive contacts 32 for attaching the cover 16 to the electronic circuitry 12. The electronic circuitry 12 comprises a plurality of key-press detection components 20, as described above. Alternatively or additionally, the cover 16 can be attached or fixed to the keypad 14 (not shown in FIG. 6) by adhesive contact pads 32 in the same way as shown in FIG. 6 with respect to the connection between the cover 16 and the electronic circuitry 12. The use of adhesive contacts or pads 32 as described with reference to FIG. 6 ensures a strong connection between the cover (e.g. mesh) 16 and the keypad 14 and/or electronic circuitry 12.

A cross-section of the secure data entry device 10 according to an embodiment of the invention is depicted in FIG. 7. In FIG. 7, the secure data entry device 10 is formed from a stack of 8 layers. Signals 34 resulting from keypad presses are primarily routed within layers 3, 4, 5 and 6. Covers, or meshes, 16a, 16b are provided within layers 2 and 7 in the form of conductive traces so as to provide additional security to the layers primarily used for routing sensitive signals. Signals 36 resulting from an attempt to remove or disturb one or both of the meshes 16a, 16b are routed between layer 2 and layer 7.

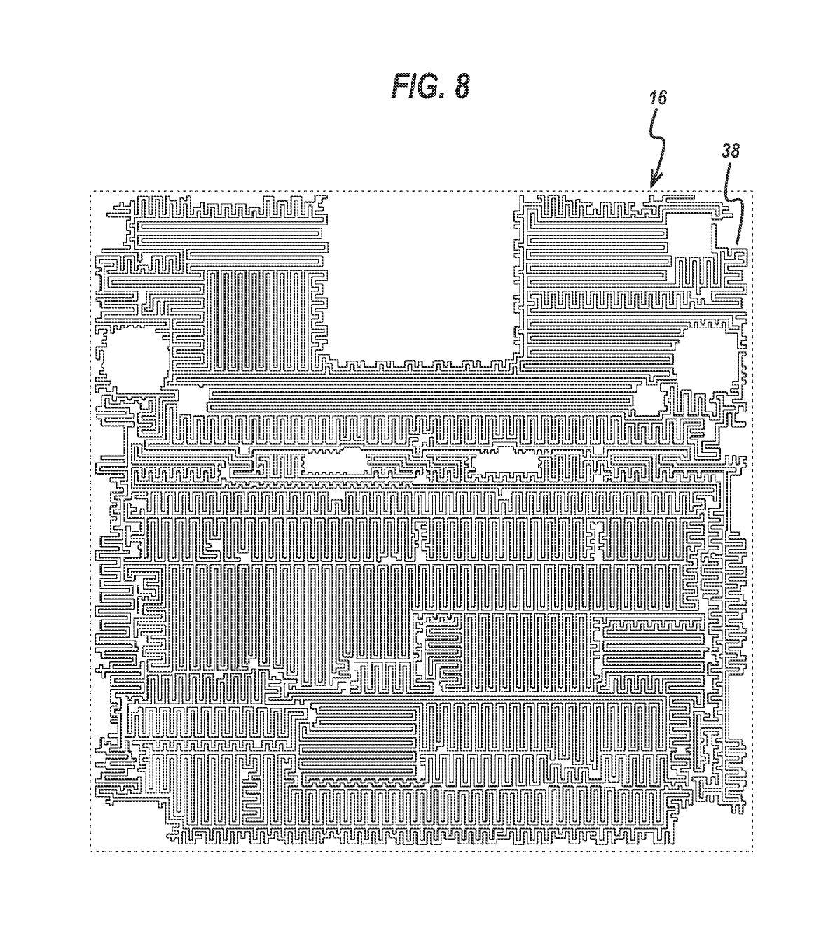

One embodiment of a conductive trace 38 present within a cover 16 (i.e. mesh) of the secure data entry device is depicted in FIG. 8. It can be seen here that the traces run parallel over short distances but there is no long range order to the arrangement.

In embodiments where the secure data entry device 10 is configured to receive data from a card, the electronic circuitry 12 further comprises a card reader (not shown in the drawings) for receiving a card containing data. The electronic circuitry 12 comprises processing circuitry for processing data read by the card reader and data input using the keypad. In some embodiments, the card reader comprises an integrated circuit card (ICC) receptor or a smartcard receptor.

The secure data entry device 10 further comprises a user interface in communication with the electronic circuitry 12, such as the processor mentioned above. The user interface comprises a display, such as an LCD display screen.

In some embodiments, the secure data entry device is configured to be powered by one or more batteries. Alternatively, the secure data entry device may be solar-powered or powered by plugging it into an electric socket.

There is also provided a system (not shown) comprising a secure data entry device 10 according to any embodiment of the invention and a communication device, wherein the secure data entry device 10 and the communication device are configured to communicate with each other.

In some embodiments, the secure data entry device 10 comprises a Bluetooth module, and the secure data entry device 10 and the communication device are configured to communicate with each other via Bluetooth. The communication device may be a mobile communication device (MCD), such as a smartphone. Alternatively, the communication device could be a PC, tablet device or any other communication device. The communication device is configured to communicate with an external system by means of an application or program stored on the MCD. The external system may be a payment acquirer.

The present invention has been described above in exemplary form with reference to the accompanying drawings which represent embodiments of the invention. It will be understood that many different embodiments of the invention exist, and that these embodiments all fall within the scope of the invention as defined by the following claims.

1. A secure data entry device comprising:
electronic circuitry;
a keypad in communication with the electronic circuitry for inputting data; and
a cover arranged between the keypad and the electronic circuitry to prevent access to the electronic circuitry.

2. The secure data entry device according to claim 1, wherein the cover comprises a mesh.

3. The secure data entry device according to claim 2, wherein the mesh is a fine wire mesh.

4. The secure data entry device according to claim 2 or claim 3, wherein the mesh comprises a metallic material.

5. The secure data entry device according to any one of claims 2 to 5, wherein the mesh is separate from the keypad.

6. The secure data entry device according to any one of claims 2 to 5, wherein the mesh is secured in place on the electronic circuitry with adhesive.

7. The secure data entry device according to any one of the preceding claims wherein the keypad comprises at least one key.

8. The secure data entry device according to any one of the preceding claims wherein the keypad comprises a plurality of keys.

9. The secure data entry device according to any one of the preceding claims wherein the keypad comprises sixteen keys, or sixteen keys or more.

10. The secure data entry device according to any one of claims 7 to 9, wherein the electronic circuitry comprises a key-press detection component corresponding to each key.

11. The secure data entry device of claim 10, wherein each key is arranged to be in communication with its corresponding key-press detection component such that a key-press of each key is detectable by the electronic circuitry.

12. The secure data entry device of claim 10 or claim 11, wherein the cover is located between a key-press component and its corresponding key.

13. The secure data entry device of any one of claims 10 to 12, wherein each key-press component comprises:
a conductive inner component on the electronic circuitry;
a conductive outer component on the electronic circuitry; and
a conductive dome,
wherein a portion of the dome is in contact with the outer component.

14. The secure data entry device of claim 13, wherein the conductive inner component is a conductive inner spot or a conductive inner ring and the conductive outer component is a conductive outer ring.

15. The secure data entry device according to claim 13 or claim 14, wherein the dome is a convex dome extending away from the electronic circuitry.

16. The secure data entry device according to any one of claim 13 to claim 15, wherein the dome is deformable between a first position in which the dome does not contact the inner component and a second position in which the dome contacts the inner component.

17. The secure data entry device according to any one of claims 13 to 16, wherein the inner component, the outer component and/or the dome comprise metallic material.

18. The secure data entry device according to any one of claims 13 to 17, wherein the dome is secured in place on the electronic circuitry with adhesive.

19. The secure data entry device according to any one of claims 13 to 18, wherein the dome is secured in place on the electronic circuitry with adhesive tape.

20. The secure data entry device according to any one of claims 7 to 19, wherein the cover is in contact with or fixed to at least one key, thereby holding it in a fixed position relative to the at least one key.

21. The secure data entry device according to any one of claims 8 to 20 when dependant on claim 8, wherein the cover is in contact with a plurality of keys, thereby holding it in a fixed position relative to the keys.

22. The secure data entry device according to any one of claims 8 to 21, when dependant on claim 8, wherein the cover is in contact with four keys or four keys or more, or all of the keys, thereby holding it in a fixed position relative to the keys.

23. The secure data entry device according to any one of claims 20 to 22, wherein each one or more keys which contact the cover are positioned at a corner of the keypad.

24. The secure data entry device according to any one of the preceding claims, wherein the electronic circuitry further comprises at least one security element or a plurality of security elements.

25. The secure data entry device according to claim 24, wherein the electronic circuitry further comprises four security elements.

26. The secure data entry device according to claim 24 or claim 25, wherein each security element comprises an inner security component and an outer security component.

27. The secure data entry device according to claim 26, wherein the inner security component is an inner security ring and the outer security component is an outer security ring.

28. The secure data entry device according to any one of claims 24 to 27, wherein the electronic circuitry is adapted to detect changes in conductivity via at least one of the security element(s).

29. The secure data entry device according to any one of claims 24 to 28, wherein at least one security element, a plurality of security elements, or all of the security element(s) is/are connected to the cover.

30. The secure data entry device according to any one of the preceding claims, wherein the electronic circuitry further comprises a card reader for receiving a card containing data.

31. The secure data entry device according claim 30, wherein the electronic circuitry comprises processing circuitry for processing data read by the card reader and data input using the keypad.

32. The secure data entry device according to claim 30 or claim 31, wherein the card reader comprises an integrated circuit card (ICC) or smartcard receptor.

33. The secure data entry device according to any one of the preceding claims, further comprising a user interface in communication with the electronic circuitry.

34. The secure data entry device according to claim 33, wherein the user interface comprises a display.

35. The secure data entry device according to any one of the preceding claims, wherein the secure data entry device is a personal identification number (PIN) entry device (PED).

36. The secure data entry device according to any one of the preceding claims, wherein the electronic circuitry is a circuit board, such as a printed circuit board.

37. A system comprising:
a secure data entry device according to any one of the previous claims; and
a communication device,
wherein the secure data entry device and the communication device are configured to communicate with each other.

38. A system according to claim 37, wherein the communication device is configured to communicate with an external system.

39. A system according to claim 38, wherein the external system is a payment acquirer.

40. The secure data entry device as hereinbefore described with reference to the accompanying drawings.

41. A system as hereinbefore described with reference to the accompanying drawings.
